(19) United States
(12) Patent Application Publication
(10) Pub. No.: US 2009/0083651 A1
(43) Pub. Date: Mar. 26, 2009

(54) METHOD TO MANAGE DRIVER PROGRAM OF IMAGE FORMING APPARATUS, AND APPARATUS THEREOF

(75) Inventors: Young-gu KIM, Suwon-si (KR); Sang-hyup Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/049,525

(22) Filed: Mar. 17, 2008

(30) Foreign Application Priority Data
Sep. 21, 2007 (KR) 2007-96958

(51) Int. Cl. G06F 9/445; G06F 1/00; G06F 3/048

(52) U.S. Cl. 715/771; 717/174; 713/100

(57) ABSTRACT

A method to manage a driver program includes starting an installation of a driver program of an image forming apparatus, setting a number of tasks to be performed using the driver program, and installing the driver program. The method further includes comparing the set number of tasks with a number of tasks actually completed, and uninstalling the driver program if the number of tasks actually completed reaches the set number of tasks. Accordingly, a driver program of an image forming apparatus can be more efficiently managed.

### CROSS-REFERENCE TO RELATED APPLICATIONS

This application claims priority under 35 U.S.C. § 119 (a) from Korean Patent Application No. 10-2007-96958, filed on Sep. 21, 2007, in the Korean Intellectual Property Office, the disclosure of which is incorporated herein by reference in its entirety.

### BACKGROUND OF THE INVENTION

1. Field of the Invention

The present general inventive concept relates to a method to manage a driver program of an image forming apparatus and an apparatus thereof, and more particularly, to a method to manage a driver program of an image forming apparatus, which sets a number of printing tasks in installing a driver program of an image forming apparatus and removes the installed driver program when the number of tasks completed reaches the preset number, and an apparatus thereof.

2. Description of the Related Art

With the development of network technology, a plurality of host devices are connected with a plurality of image forming apparatuses via wire/wireless network. An image forming apparatus refers to an apparatus that is capable of printing received task data on paper, receiving a fax, and also making a copy with respect to a document. Such an image forming apparatus may include a photocopier, a fax machine, a printer, and a multifunction peripheral which integrates functions of a photocopier, a fax machine, and a printer in one device.

The host device may be a desktop computer which is in a fixed location and a laptop which is portable. Besides the desktop computer and laptop, with the recent development of portable devices, a digital camera, a mobile phone, a personal digital assistant (PDA), and a camcorder are widely used as a host device. Accordingly, the host device according to the present general inventive concept is not limited to a desktop computer or laptop.

In order to use a computer for the specific purpose intended by a user, the user has to install extra software in the computer. Software frequently installed by users includes an application program and a driver program of an image forming apparatus. The application program is created on purpose to perform a specific task, and may be office programs such as Excel, Word, and PowerPoint, word processors, and statistical software.

The driver program of an image forming apparatus enables communications between the image forming apparatus and the host device, and allows the host device to control the image forming apparatus.

The driver program is provided by a manufacturer for a user purchasing an image forming apparatus, or provided through a manufacturer's homepage on the world-wide-web (WWW). A user downloads a driver program corresponding to a model name of an image forming apparatus and installs the driver program in the host device. The driver program, which has been once downloaded and installed, has to be uninstalled or removed directly by the user. More specifically, in order to uninstall a driver program, conventionally, the following ways has been adopted:

A driver program is uninstalled using a Remove Program. More specifically, an uninstalling operation is performed by selecting the following menus or commands Go to>Choose Start>All Programs>installed driver (for example, Samsung SCX-111 Series)>Remove button.

An uninstalling operation is also performed in a printer and fax folder. More specifically, an uninstalling operation is performed by selecting the following menus or commands: Go to>Choose Start>Control Panel>Printer and Fax>Driver>Right Click on Computer>Click on “Remove”. Alternatively, an uninstalling is performed by following these steps: Right Click on Empty Space of Printer and Fax Folder>Choose Server Attribute>Driver tab>Driver>Click on “Remove”.

Alternatively, a portable laptop does not restrict freedom in moving and thereby enables a task to be performed in any place. However, when necessary, the portable laptop needs a printing task, and in order to perform the printing task, the laptop has to install a driver program therein. The laptop has to install every driver program according to a manufacturer and a model name of an image forming apparatus located in a work place where the laptop is located. As a result, several tens of driver programs are installed. Therefore, in order to remove a driver program which has been used but currently does not need to be used any more, the above complicated procedure is required with respect to each drive program, which causes an inconvenience to the user.

### SUMMARY OF THE INVENTION

The present general inventive concept provides a method to manage a driver program of an image forming apparatus, which is capable of uninstalling a driver program at a proper time based on a number of tasks which has been previously set with respect to the driver program and a number of tasks which has been actually completed, and a managing apparatus thereof.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a method to manage a driver program of a managing apparatus which is connected with an image forming apparatus in a wire/wireless manner and controls the image forming apparatus, the method including starting an installation of a driver program of the image forming apparatus, setting a number of tasks to be performed using the driver program, and installing the driver program.

The method may further include comparing the set number of tasks with a number of tasks actually completed.

The method may further include displaying at least one of the set number of tasks and the number of tasks actually completed.

The method may further include uninstalling the driver program if the number of tasks actually completed reaches the set number of tasks.

The method may further include prompting a user as to whether to uninstall the driver program before uninstalling the driver program.

An uninstalling operation of the driver program may be performed through a user interface (UI) of the driver program.

The set number of tasks may change.

The method may further include performing an authentication to change the set number of tasks.

The driver program may be uninstalled before the number of tasks actually completed reaches the set number of tasks.

The uninstalling operation of the driver program may be performed through an application program to execute the driver program.

If a printing task is performed through the application program, at least one of the set number of tasks and the number of printing tasks actually completed may be displayed.

The method may further include uninstalling the driver program if the managing apparatus is released from the wire/wireless connection with the image forming apparatus.

The method may further include prompting a user as to whether to uninstall the driver program before uninstalling the driver program.

The method may further include deducting one from the number of tasks actually completed if a task is started but then canceled.

The foregoing and/or other aspects and utilities of the general inventive concept may also be achieved by providing a managing apparatus to control an image forming apparatus, the apparatus including a storage unit to store a number of tasks which is preset for a driver program of the image forming apparatus, and a controller to uninstall the driver program if a number of tasks actually completed using the driver program reaches the preset number of tasks.

The managing apparatus may further include a user interface (UI) processing unit to provide a UI to prompt a user as to whether to uninstall the driver program, wherein the controller uninstalls the driver program if a command to uninstall the driver program is input through the UI.

The managing apparatus may further include a user interface (UI) processing unit to change the number of tasks and to perform an authentication as to the change.

The managing apparatus may further include a user interface (UI) processing unit to provide a UI displaying a selection menu to be able to uninstall the driver program even if the number of tasks actually completed is smaller than the preset number of tasks, the preset number of tasks, and the number of tasks actually completed.

The controller may prompt a user as to whether to remove the driver program if the managing apparatus is released from a wire/wireless connection with the image forming apparatus, and remove the driver program according to the result of the prompting.

The controller may count the accumulated number of tasks actually completed every time that each printing operation is performed, and deduct one from the number of tasks actually completed if a task is canceled.

The controller may remove the driver program through an application program to perform a printing task.

The foregoing and/or other aspects and utilities of the general inventive concept may also be achieved by providing a managing apparatus usable with an image forming apparatus, the managing apparatus including a controller to prompt a user for a confirmation to uninstall a driver program based on a number of task previously set with respect to the driver program and a number of completed tasks, and to uninstall the driver program based on the confirmation, and a user interface through which a user sets the number of tasks, and through which the controller prompts the user for the confirmation to uninstall the driver program.

The foregoing and/or other aspects and utilities of the general inventive concept may also be achieved by providing a driver managing system including an image forming apparatus to perform one or more image forming operations, a host device to establish a connection with the image forming apparatus, and a controller to prompt a user for a confirmation to uninstall a driver program based on the connection between the host device and the image forming apparatus being disconnected, and to uninstall the driver program based on the confirmation by the user.

The driver managing system may include a user interface through which the user is prompted by the controller for confirmation to uninstall the driver program.

The host apparatus may include a mobile electronic device.

The foregoing and/or other aspects and utilities of the general inventive concept may also be achieved by providing a driver managing method including prompting a user for a confirmation to uninstall a driver program based on a number of tasks previously set with respect to the driver program and a number of completed tasks, and uninstalling the driver program based on the confirmation by the user.

The foregoing and/or other aspects and utilities of the general inventive concept may also be achieved by providing a computer-readable recording medium having embodied thereon a computer program to execute a method, wherein the method including prompting a user for a confirmation to uninstall a driver program based on a number of tasks previously set with respect to the driver program and a number of completed tasks, and uninstalling the driver program based on the confirmation by the user.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating a managing apparatus according to an exemplary embodiment of the present general inventive concept;

FIG. 2 is a view illustrating an example of a user interface (UI) provided by the managing apparatus of FIG. 1;

FIG. 3 is a flowchart illustrating a process of installing a driver program of a method to manage a driver program according to an exemplary embodiment of the present general inventive concept;

FIG. 4 is a view illustrating an authenticating process required to set a number of printing tasks during the process of installing a driver program;

FIG. 5 is a flowchart illustrating a method to manage a driver program according to an exemplary embodiment of the present general inventive concept;

FIG. 6 is a view illustrating an example of a UI provided by the method to manage a driver program according the exemplary embodiment as illustrated in FIG. 5; and

FIG. 7 is a view illustrating an example of a UI provided according to another exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

FIG. 1 is a block diagram illustrating a managing apparatus according to an exemplary embodiment of the present general inventive concept. Referring to FIG. 1, the managing apparatus includes a storage unit 110, a controller 120, and a UI processing unit 130. This managing apparatus may be a host PC that is connected to an image forming apparatus through a network or a local interface and controls the image forming apparatus, or may be an image forming apparatus. Also, the UI processing unit 130 may be omitted according to variants of embodiments of the present general inventive concept, and additional elements not illustrated in FIG. 1 may be included.

The storage unit 110 may store a driver program installed for at least one image forming apparatus, i.e., may be embodied as at least one memory including an installed memory area. In this case, the storage unit 110 may also store a number of tasks which has been previously set for each of installed driver programs. That is, in order to use a specific image forming apparatus, a user of the respective managing apparatus connects the managing apparatus to the image forming apparatus through a network or local interface. If a driver program of the corresponding image forming apparatus has been already installed, the user can perform various tasks using the installed driver program. However, if a corresponding driver program is not installed, the user has to install a driver program from a driver CD or web-server. During the process of installing a driver program, the user is allowed to set a number of tasks to be performed using the installed driver program. That is, the user predicts in advance how many times the user will use the corresponding image forming apparatus, and sets the number of tasks during the process of installing the driver program.

The controller 120 counts the accumulated number of tasks when a specific task such as printing or scanning is performed using the driver program. Accordingly, the controller 120 calculates the number of tasks actually completed and compares the number of completed tasks with the preset number of tasks. As a result of comparison, if the number of tasks currently completed is smaller than the preset number, the driver program is maintained and continuously used. If the current number of tasks completed reaches the preset number, the installed driver program is removed, i.e., uninstalled so that the driver program cannot be used any more.

The various operations of the controller 120 are directly selected by the user through a UI provided by the UI processing unit 130.

More specifically, the UI processing unit 130 provides a UI to prompt a user as to whether to uninstall the driver program. The UI is provided under the control of the controller 120 when the number of tasks actually completed using the corresponding driver program is equal to the preset number.

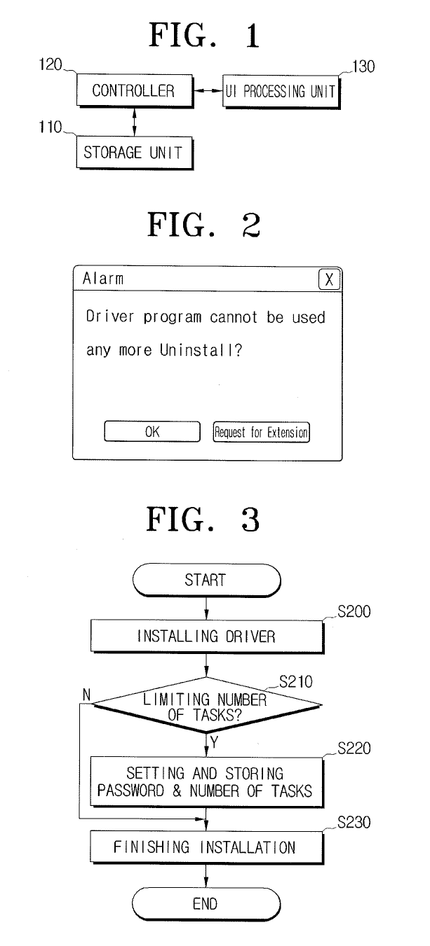

FIG. 2 illustrates an example of a UI provided when the number of tasks actually completed is equal to the preset number. Referring to FIG. 2, along with an alarming message that the corresponding driver program cannot be used any more, the menu “OK” to uninstall the driver program and a menu to extend the preset number of tasks are displayed. If the menu “OK” is selected through the UI, the controller 120 uninstalls the driver program.

Alternatively, if the menu “Request for Extension” is selected, the controller 120 performs a process of extending the preset number of tasks. In this case, in order to prevent the preset number of tasks from being arbitrarily changed, an authentication process is preferably required. More specifically, the UI processing unit 130 provides an UI to change the preset number of tasks and to perform an authentication process as to the change. Accordingly, the controller 120 changes the preset number of tasks as a user newly inputs only when the user correctly inputs an authentication password and the authentication succeeds, and stores the changed number of tasks in the storage unit 110.

If the preset number of tasks is changeable as described above, the number of times that the tasks have been completed can be indicated to the user. For this, the UI processing unit 130 may provide a UI to display the preset number of tasks along with the number of task actually completed, or alternatively, to display the number of remaining tasks which can be obtained by subtracting the number of tasks actually completed from the preset number of tasks.

Meanwhile, a user may wish to uninstall the corresponding driver program although the number of tasks actually completed is smaller than the preset number of tasks.

For this, the UI processing unit 130 provides a UI having a selection menu to uninstall the driver program even in a state that the number of tasks actually completed is smaller than the preset number of tasks.

As described above, the UI processing unit 130 provides a variety of UIs so that a user can manage the driver program more efficiently.

Also, the UI processing unit 130 may provide a single UI displaying a number of remaining tasks, a selection menu to directly remove a driver program, a selection menu to change the preset number of tasks, and an area to input an authentication password as to the change.

The controller 120 may uninstall a driver program for an image forming apparatus if the driver is released from a wire/wireless connection with the image forming apparatus. In this case, if a disconnection is detected, the controller 120 controls the UI processing unit 130 to provide a UI to prompt the user as to whether to uninstall the driver program, and then uninstalls the corresponding driver program if a driver program uninstalling command is input through the UI.

The controller 120 may be operated during a process of executing an application program. That is, if various tasks using an image forming apparatus are selected during the process of executing various application programs such as MS-word or Jungum Global, the controller 120 compares the number of tasks actually completed with the preset number of tasks and maintains or removes the driver program. In this case, an application execution window additionally displays on a menu selection area a selection menu to directly uninstall a driver program of an image forming apparatus.

FIG. 3 is a flowchart illustrating a process of installing a driver program of an image forming apparatus according to a method to manage a driver program according to an exemplary embodiment of the present general inventive concept. The installing process of FIG. 3 is executed in the managing apparatus of FIG. 1. In operation S200, in a state that the image forming apparatus is connected with the managing apparatus i.e. with the host device in a wire/wireless manner, or the image forming apparatus and the managing apparatus are not connected with each other, a setup file of a driver program of the image forming apparatus, which is recoded in an installation CD or downloaded from the Internet, is selected and installed. In some cases, a program driver is automatically installed without selecting a setup file if the image forming apparatus is connected with the host device. In operation S210, during the installation, a determination is made whether the driver program is set to be removed based on the number of tasks.

Herein, “the number of tasks” refers to of the counted number of printing, photocopying, or fax sending operations performed using the driver program. The number of tasks is not counted simply if a driver program icon is selected and a driver window is opened, or if options for printing, photocopying, and faxing are set-up on the opened driver window.

If the driver program is set to be removed based on the number of tasks, in operation S220, a process of setting the number of tasks and an authentication password required in changing the number of tasks and storing the task is performed.

The number of tasks is an essential setting item, and the authentication password is an optional item. If no authentication password is set, the driver program is directly removed without inputting a password during the process of deleting, as will be described below.

Also, if no authentication password is set, a password required to log-in a windows program of Microsoft, which is one of an operating system installed in a computer, is automatically set as a default for the authentication password.

If the user does not wish that the driver program is removed based on the number of tasks, the operation S220 is bypassed.

If a series of installing processes is completed after setting and storing the number of tasks and the authentication password, in operation S230, the driver program is completely installed.

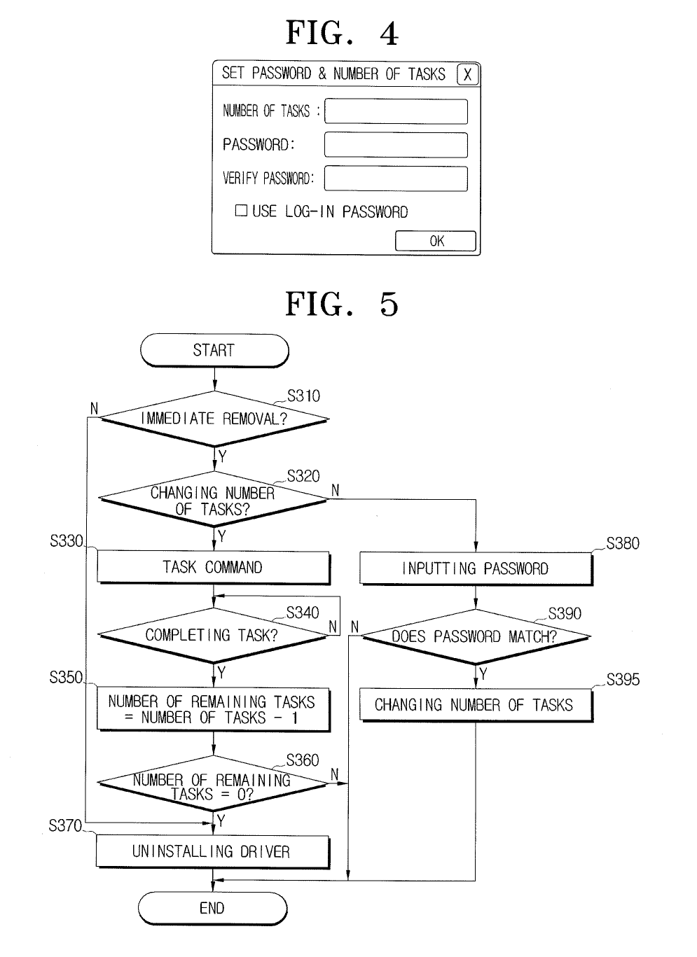

FIG. 4 illustrates an example of an input window through which a user sets a number of tasks and a password. The input window may be provided on an installation view of the driver program, or may be provided as a separate window illustrated in FIG. 4.

If the number of tasks and the authentication password are input and then the OK button is selected, the number of tasks and the authentication password are stored to the host device. These are stored to a same area as the driver program, or may be stored to a preset extra storage area.

Alternatively, if the OK button is selected without inputting a password or verifying the password, the menu “Use a log-in password” is automatically selected so that a log-in password serves as an authentication password.

FIG. 5 is a flowchart illustrating a method to manage a driver program of an image forming apparatus according to an exemplary embodiment of the present general inventive concept.

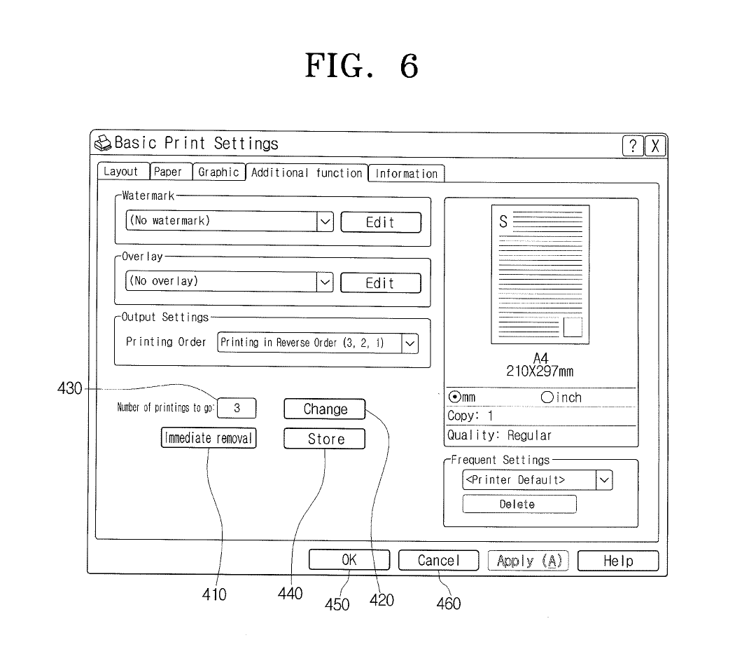

A user may install and use a driver program of an image forming apparatus in a manner as illustrated in FIG. 3. If the user executes the driver program to perform a task, a UI is displayed. An example of the displayed UI is illustrated in FIG. 6. Hereinafter, with reference to FIGS. 5 and 6, the exemplary embodiment of the present general inventive concept will be described.

The user opens a printer driver window or an execution window of various applications by selecting various icons on the managing apparatus. The opened window has a menu “Remove” 410 to directly remove a driver program regardless of the number of remaining tasks, i.e., to uninstall a driver program. In operation S310, if a user selects the menu “Remove” 410 to directly remove the driver program, in operation S370, the driver program is directly uninstalled. For the convenience of explanation, although the process S310 of directly deleting a driver program is performed in FIG. 5, the uninstalling operation by selecting the menu “Remove” 410 may be performed at any time with respect the deleting process S310.

Also, the user may try to change the number of tasks through the UI. That is, a command to change the number of tasks is input through the UI displayed on the managing device or the image forming apparatus. That is, the UI provides an area 430 displaying the number of remaining tasks and also provide a menu “Change” 420 to change the number of tasks.

If the menu “Change” 420 is selected, that is, if the user wishes to change the number of remaining tasks, in operation S380, an extra pop-up window is provided to be input with an authentication password and is input with an authentication password. In operation S390, if the input authentication password is identical to that previously set through the UI illustrated in FIG. 4, in operation S395, the number of tasks is changed and stored. The changed number of tasks is set to be stored when a menu “Store” 440 is selected. If the input password is not identical to preset authentication password, a message indicating the discrepancy is displayed through a pop-up window. As described above, the number of tasks may increase or decrease through an authenticating process.

The process of deleting the driver program in operations S310 and S370 and the process of changing the number of tasks in operations S320, S380, S390, and S395 may be performed at anytime separately from the tasks performed using the image forming apparatus.

Also, in operation S330, the user using such a managing apparatus may input a task command when the user wishes to do so, by executing the driver program or the application program. If a task command is input, the driver window illustrated in FIG. 6 may be displayed. On such a driver window, the user may select a “Cancel” button 460 to cancel the task or select the “OK” button 450 to execute the task, without changing the number of tasks 430.

In operation S340, if a task is executed and completed, in operation S350, the number of remaining tasks decreases by 1.

In operation S360, if the number of remaining tasks 430 is 0 as all of tasks is completed, in operation S370, the driver program for the image forming apparatus is automatically uninstalled without requiring a user's additional manipulation. During this automatic uninstalling process, the user may be aware of that the deletion of the driver program is being processed through a pop-up window. The pop-up window may be configured as illustrated in FIG. 2. That is, the driver program may be automatically uninstalled, or may be uninstalled after prompting the user as to whether to uninstall the driver program.

As described above, FIG. 6 illustrates an example of a UI of a driver program of an image forming apparatus according to an exemplary embodiment of the present general inventive concept. Referring to FIG. 6, the UI includes tabs to set various options to operate the image forming apparatus. In FIG. 6, the respective tabs include “Layout”, “Paper”, “Graphic”, “Additional function”, and “Information”, but the tabs may be slightly different depending on manufacturers of the image forming apparatus. Therefore, the menus, “Remove” 410 to remove the driver program of the image forming apparatus, “Change” 420, “Remaining” 430, and “Store” 440 are not limited to a specific tab.

In a network environment, a network administrator may set a limit of the number of tasks in installing a driver in a client PC, and also may adjust the number of tasks and directly remove the driver at the request from the client. This is similar to that of the embodiment of the present general inventive concept illustrated in FIG. 1.

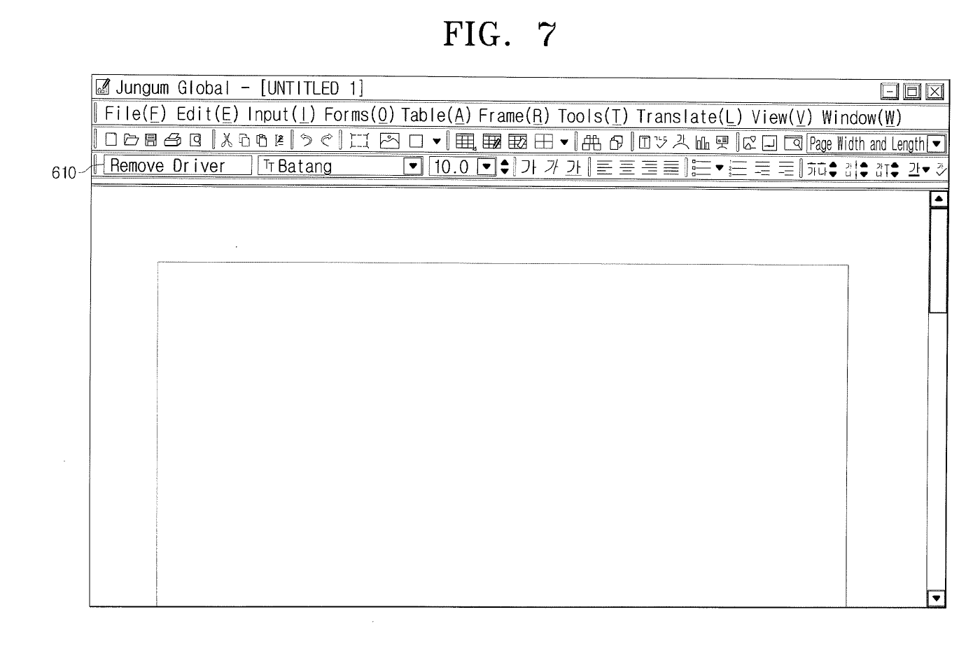

FIG. 7 illustrates an application using a driver program of an image forming apparatus, to which the present general inventive concept is applicable according to another exemplary embodiment of the present general inventive concept.

The menu “Remove Driver” is created or added as a plug-in to the tool menu located an upper end of the current application program. If the menu “Remove Driver” is selected, the driver program installed in the current application is directly removed. Additionally, a user's confirmation as to the removal may be required before the driver program is directly removed. Accordingly, taking several operations to remove the driver program can be avoided.

If a printing task is performed in an application, the number of remaining tasks is displayed on a pop-up window, along with a deletion button so that a user is aware of the number of remaining tasks. Accordingly, if the user selects the deletion button, the driver program is removed, for example, right after a printing task is completed, regardless of the number of remaining tasks. Also, if the number of remaining tasks reaches a predetermined threshold such as 1 time, or if no tasks remain, a change button is provided on the pop-up window so that the user can change the number of remaining tasks.

Recently, a mobile device (e.g. laptops) is used as a host device and uses an image forming apparatus. Accordingly, if a mobile device is released from a connection with a printer, a pop-up window is displayed to inform the user that the printer is disconnected from the mobile device. In this case, the pop-up window provides a message that a driver could be removed and also a selection menu to remove the driver, such that the user can input a command as to whether to remove the driver. If the user selects the deletion, the driver is directly removed.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

According to various embodiments of the present general inventive concept, a driver program of an image forming apparatus is uninstalled at a proper time and thus a system can be efficiently managed. More specifically, a user can set a number of tasks in installing a driver program of an image forming apparatus, and is prompted as to whether to remove the driver program when a number of tasks completed reaches the preset number, and if a user selects the deletion, the driver program is directly removed without requiring a complicated procedure. Also, removal of the driver program through an application program is possible, and thus, a user's convenience concerning the managing of the driver program can be improved.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method to manage a driver program of a managing apparatus which is connected with an image forming apparatus in a wire/wireless manner and controls the image forming apparatus, the method comprising:
initiating an installation of a driver program of the image forming apparatus;
setting a number of tasks to be performed using the driver program; and
installing the driver program.

2. The method as claimed in claim 1, further comprising:
comparing a set number of tasks with the number of tasks actually completed.

3. The method as claimed in claim 2, further comprising:
displaying at least one of the set number of tasks and the number of tasks actually completed.

4. The method as claimed in claim 2, further comprising:
uninstalling the driver program if the number of tasks actually completed reaches the set number of tasks.

5. The method as claimed in claim 4, further comprising:
prompting a user as to whether to uninstall the driver program before uninstalling the driver program.

6. The method as claimed in claim 4, wherein an uninstalling operation of the driver program is performed through a user interface (UI) of the driver program.

7. The method as claimed in claim 1, wherein the set number of tasks is changeable.

8. The method as claimed in claim 7, further comprising:
performing an authentication to change the set number of tasks.

9. The method as claimed in claim 4, wherein the driver program is uninstalled before the number of tasks actually completed reaches the set number of tasks.

10. The method as claimed in claim 4, wherein the uninstalling operation of the driver program is performed through an application program to execute the driver program.

11. The method as claimed in claim 10, wherein, if a printing task is performed through the application program, at least one of the set number of tasks and the number of printing tasks actually completed is displayed.

12. The method as claimed in claim 1, further comprising:
uninstalling the driver program if the managing apparatus is released from the wire/wireless connection with the image forming apparatus.

13. The method as claimed in claim 12, further comprising:
prompting a user as to whether to uninstall the driver program before uninstalling the driver program.

14. The method as claimed in claim 4, further comprising:
deducting one from the number of tasks actually completed if a task is started but then canceled.

15. A managing apparatus to control an image forming apparatus, the apparatus comprising:
a storage unit to store a number of tasks which is preset for a driver program of the image forming apparatus; and
a controller to uninstall the driver program if a number of tasks actually completed using the driver program reaches the preset number of tasks.

16. The managing apparatus as claimed in claim 15, further comprising a user interface (UI) processing unit to provide a UI to prompt a user as to whether to uninstall the driver program, wherein the controller uninstalls the driver program if a command to uninstall the driver program is input through the UI.

17. The managing apparatus as claimed in claim 15, further comprising:
a user interface (UI) processing unit to change the number of tasks and to perform an authentication as to the change.

18. The managing apparatus as claimed in claim 15, further comprising:
a user interface (UI) processing unit to provide a UI displaying a selection menu to be able to uninstall the driver program even if the number of tasks actually completed is smaller than the preset number of tasks, the preset number of tasks, and the number of tasks actually completed.

19. The managing apparatus as claimed in claim 15, wherein the controller prompts a user as to whether to remove the driver program if the managing apparatus is released from a wire/wireless connection with the image forming apparatus, and removes the driver program according to the result of the prompting.

20. The managing apparatus as claimed in claim 15, wherein the controller counts and accumulates the number of tasks actually completed every time the printing operation is completed, and deducts one from the number of tasks actually completed if a task is canceled.

21. The managing apparatus as claimed in claim 15, wherein the controller removes the driver program through an application program to perform a printing task.

22. A managing apparatus usable with an image forming apparatus, the managing apparatus comprising:
a controller to prompt a user for a confirmation to uninstall a driver program based on a number of task previously set with respect to the driver program and a number of completed tasks, and to uninstall the driver program based on the confirmation; and
a user interface through which a user sets the number of tasks, and through which the controller prompts the user for the confirmation to uninstall the driver program.

23. A driver managing system, comprising:
an image forming apparatus to perform one or more image forming operations;
a host device to establish a connection with the image forming apparatus;
a controller to prompt a user for a confirmation to uninstall a driver program based on the connection between the host device and the image forming apparatus being disconnected, and to uninstall the driver program based on the confirmation by the user; and,
a user interface through which the user is prompted by the controller for confirmation to uninstall the driver program.

24. A driver managing method, comprising:
prompting a user for a confirmation to uninstall a driver program based on a number of tasks previously set with respect to the driver program and a number of completed tasks; and
uninstalling the driver program based on the confirmation by the user.

25. A computer-readable recording medium having embodied thereon a computer program to execute a method, wherein the method comprises:
prompting a user for a confirmation to uninstall a driver program based on a number of tasks previously set with respect to the driver program and a number of completed tasks; and
uninstalling the driver program based on the confirmation by the user.
